(19) United States
(12) Patent Application Publication
(10) Pub. No.: US 2026/0355553 A1
(43) Pub. Date: Nov. 12, 2026

(54) FALL ARREST DEVICE

(71) Applicant: YOKE INDUSTRIAL CORP., Taichung City (TW)

(72) Inventors: WEI-CHIEH HUNG, Taichung City (TW); CHIA-HSIEN WANG, Taichung City (TW)

(73) Assignee: YOKE INDUSTRIAL CORP., Taichung City (TW)

(21) Appl. No.: 19/294,327

(22) Filed: Aug. 8, 2025

(30) Foreign Application Priority Data
May 9, 2025 (TW) 114117535

(51) Int. Cl. A62B 35/00

(52) U.S. Cl. CPC A62B 35/0093

(57) ABSTRACT

A fall arrest device includes a casing. An inner side of a top of the casing has a fixing seat with a fixing surface. A bottom of the casing has an exit. The top of the casing is engaged with a ring assembly. A stopper member with a stopper tooth is engaged with the fixing surface. A main shaft is fixed in a mounting space. A rotating drum is sleeved around the main shaft. A rope with an outer end extending from the exit is wound around the rotating drum to have several turns. A spiral spring is connected between the rotating drum and the main shaft. A braking assembly with several ratchet blocks around the braking assembly is engaged with a side of the rotating drum. When a rotational speed of the rotating drum exceeds a predetermined rotational speed, one ratchet block meshes with the stopper.

### BACKGROUND OF THE INVENTION

### Technical Field

The present invention relates generally to a safety apparatus, and more particularly to a fall arrest device configured to prevent a user from falling.

### Description of Related Art

A conventional fall arrest device is to fix a main shaft in a casing. A rotating drum and a ratchet gear are rotatably engaged with the main shaft. A side of the rotating drum is engaged with a braking assembly. A rope is wound onto the rotating drum to have a plurality of turns and is engaged around the rotating drum.

When the conventional fall arrest device is used, the casing is fixed to a place, and an end of the rope passing out of the casing is engaged with a wearable harness on a user. When the user wearing the wearable harness falls from height, the rotating drum in the fall arrest device rotates quickly by pulling the rope, so that the braking assembly engaged with the rotating drum changes from a state of disengaging with the ratchet gear to a state of engaging with the ratchet gear due to a centrifugal force of quick rotation. When the braking assembly is engaged with the ratchet gear, the rotating drum could be stopped from continuously rotating and releasing the rope, thereby preventing the user from continuing to fall down.

The conventional fall arrest device could prevent the user from falling. However, as the ratchet and the rotating drum in the fall arrest device are fixed to the main shaft of the casing, a length of the main shaft and a volume of the casing could not be reduced, so that a size of the fall arrest device could not be effectively reduced.

### BRIEF SUMMARY OF THE INVENTION

In view of the above, the primary objective of the present invention is to provide a fall arrest device, wherein a stopper member configured to stop a braking assembly is disposed along a longitudinal direction of the braking assembly, so that a length of main shaft and a volume of a casing are reduced, thereby reducing a size of the fall arrest device.

The present invention provides a fall arrest device having a rotation axis and including a casing, a ring assembly, a stopper member, and a core assembly. A mounting space is provided in the casing. Two side walls are respectively provided on two sides of the mounting space in an axial direction of the rotation axis. A peripheral wall is connected between the two side walls. A fixing seat is formed on a top portion of the peripheral wall. An insertion slot is formed between the fixing seat and one of the two side walls. A fixing surface is formed on the fixing seat. The fixing surface faces the insertion slot. An exit is formed at a bottom portion of the peripheral wall. The exit communicates with the mounting space. The ring assembly is engaged with the top portion of the casing. The stopper member is engaged with the fixing surface. A bottom portion of the stopper member extends downwards out of the fixing seat. A stopper tooth is formed at the bottom portion of the stopper member.

The core assembly includes a main shaft, a rotating drum, a spiral spring, a rope, and a braking assembly. The main shaft is fixed in the mounting space. The rotation axis is a central line of the main shaft. The rotating drum is rotatably sleeved around the main shaft. A side of the rotating drum is provided with a mounting portion. A spiral spring cavity is provided in the rotating drum. The spiral spring is disposed in the spiral spring cavity and is connected between the main shaft and the rotating drum. An end of the rope is engaged with the rotating drum. The rope is wound around the rotating drum in a releasable manner to form a plurality of turns. Another end of the rope extends out of the exit. The braking assembly is engaged with the mounting portion. A plurality of ratchet blocks is provided around the braking assembly. When a rotational speed of the plurality of ratchet blocks, which rotate together with the rotating drum, is greater than a predetermined rotational speed, one of the ratchet blocks meshes with the stopper tooth.

With the aforementioned design, the stopper member is engaged with the fixing seat inside the casing, the stopper tooth formed at the bottom portion of the stopper member is configured to mesh with one of the ratchet blocks, and the stopper member is basically located in a vertical direction of the braking assembly. In this way, the present invention does not require a ratchet gear or a braking structure, which is configured to mesh with the braking assembly and is disposed along an axial direction of the main shaft, thereby reducing a length of the main shaft and a size of the fall arrest device.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the fall arrest device according to an embodiment of the present invention;

FIG. 2 is an exploded view of the fall arrest device according to the embodiment of the present invention;

FIG. 2A is an enlarged view of the marked region 2A in FIG. 2;

FIG. 3 is a schematic view, showing that the side plate on the right side of the fall arrest device according to the embodiment of the present invention is separated from the casing;

FIG. 4 is a side view of the fall arrest device according to the embodiment of the present invention;

FIG. 5 is a sectional view along the 5-5 line in FIG. 4;

FIG. 6 is a sectional view along the 6-6 line in FIG. 4;

FIG. 7 is a top view of the fall arrest device according to the embodiment of the present invention; and

FIG. 8 is a sectional view along the 8-8 line in FIG. 7.

### DETAILED DESCRIPTION OF THE INVENTION

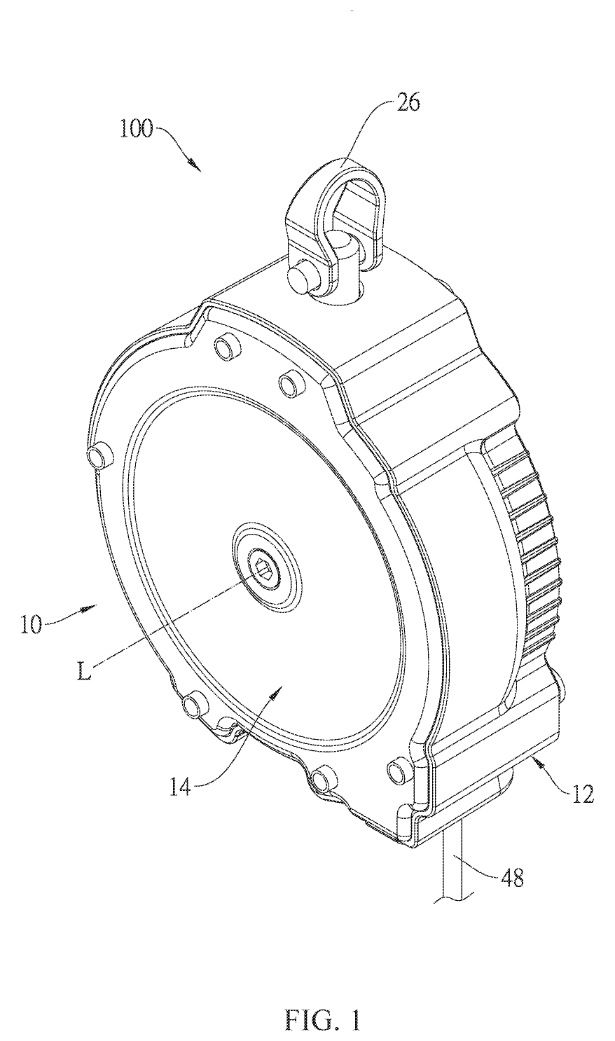

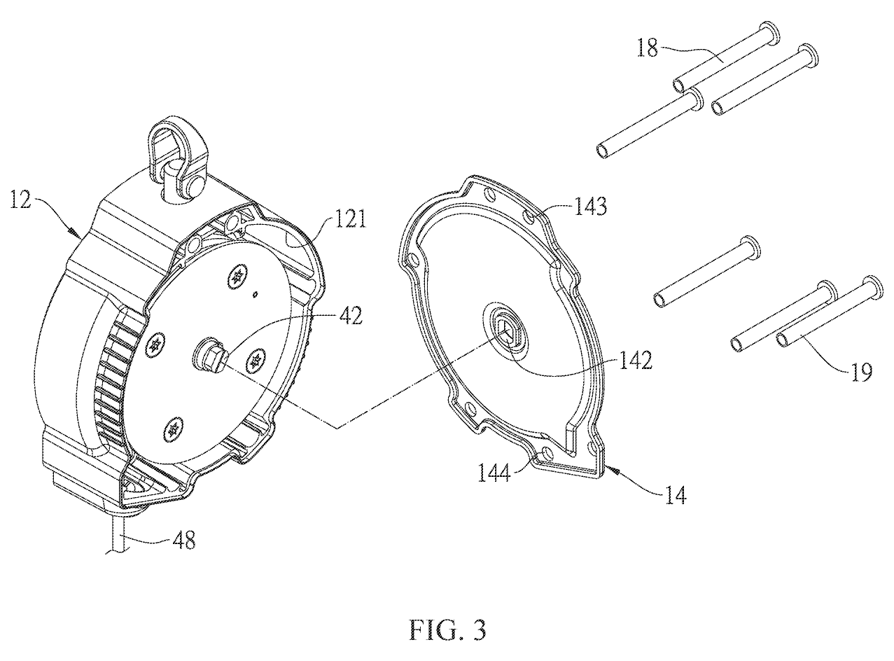

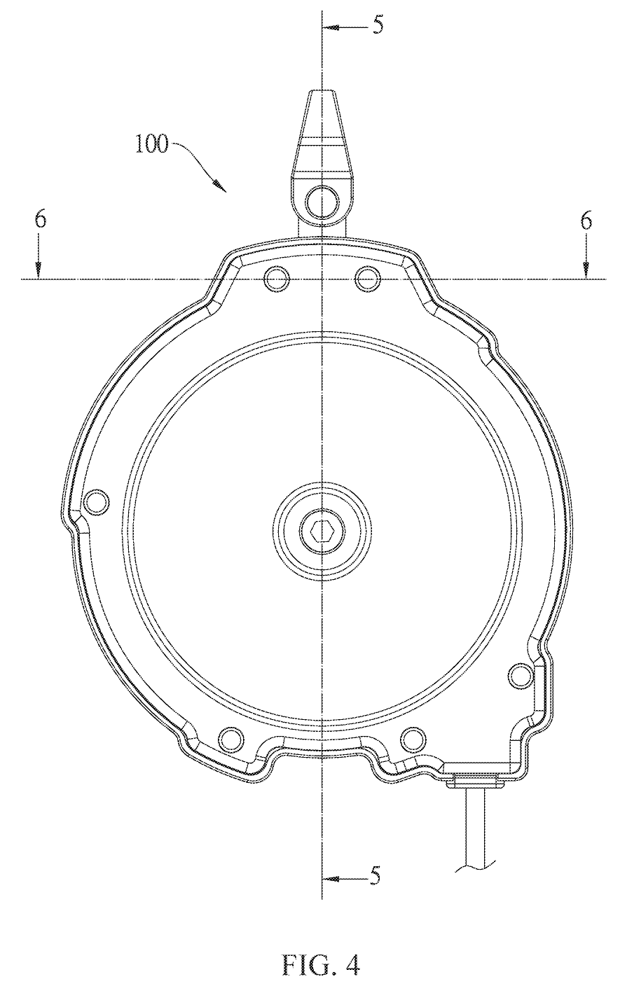

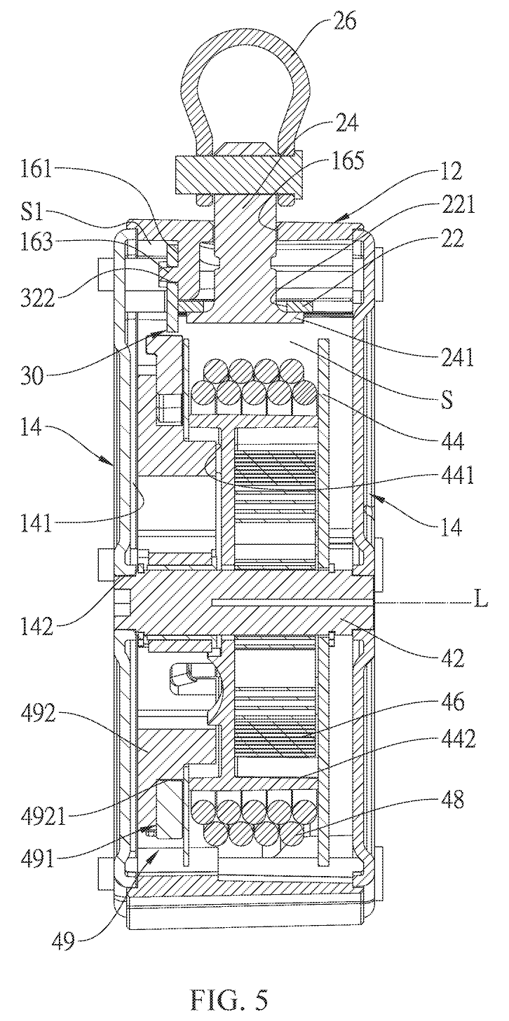

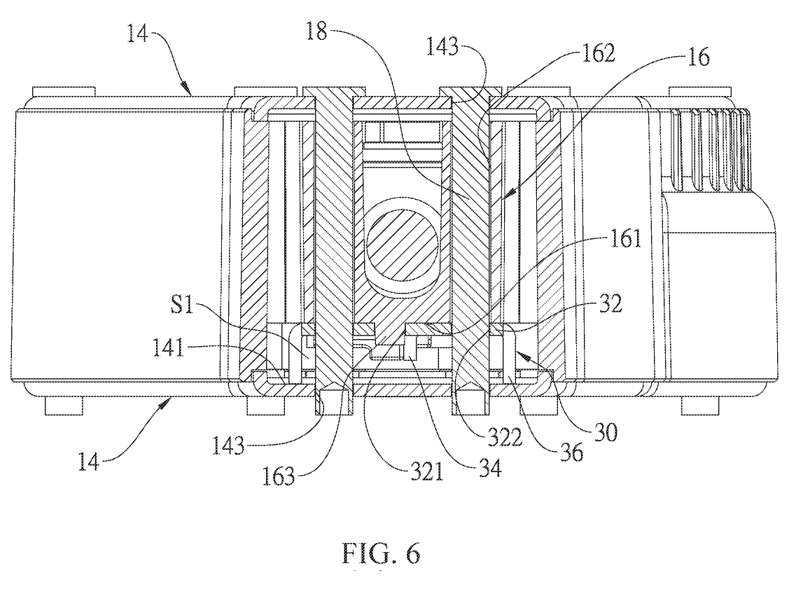

A fall arrest device 100 according to an embodiment of the present invention is illustrated in FIGS. 1-6 . In the following description of the structure of the fall arrest device 100, relative positions, namely along a top-bottom direction, a left-right direction, and a front-rear direction, are defined based on the orientation of the fall arrest device 100 during operation. The fall arrest device 100 has a rotation axis L extending along the left-right direction and includes a casing 10, a ring assembly 20, a stopper member 30, and a core assembly 40.

The casing 10 includes a peripheral plate 12 and two side plates 14. Two end edges 121 are respectively formed on an edge of a left side of the peripheral plate 12 and an edge of a right side of the peripheral plate 12, and a peripheral edge of each of the two side plates 14 is connected to one of the two end edges 121, so that the peripheral plate 12 and the two side plates 14 jointly surround and define a mounting space S. A peripheral wall 122 is formed on an inner surface of the peripheral plate 12. Two side walls 141 are respectively formed on two inner surfaces of the two side plates 14. The two side walls 141 are respectively formed on two sides of the mounting space S in an axial direction of the rotation axis L. The peripheral wall 122 is connected between the two side walls 141.

A fixing seat 16 is formed on a bottom side of a top portion of the peripheral plate 12. The fixing seat 16 is located at a top portion within the mounting space S, and a length of the fixing seat 16 along the axial direction of the rotation axis L is less than a length of the peripheral plate 12 along the axial direction of the rotation axis L. An insertion slot S1 is formed between the fixing seat 16 and one of the side walls 141. A fixing surface 161 is formed on a side of the fixing seat 16 facing one of the side walls 141 that is corresponding. In the current embodiment, the fixing surface 161 is perpendicular to the axial direction of the rotation axis L. Two perforations 162 are respectively provided at a front side and a rear side of the fixing seat 16. An extension direction of each of the perforations 162 is parallel to the axial direction of the rotation axis L.

A positioning pin 163 is provided at a middle of the fixing seat 16. The positioning pin 163 protrudes from the fixing surface 161. An insertion groove 164 is formed at a bottom portion of the fixing seat 16. A vertical hole 165 is formed at a top portion of the peripheral plate 12 and the fixing seat 16. The vertical hole 165 penetrates through the top portion of the peripheral plate 12 and the middle of the fixing seat 16 along the top-bottom direction. A bottom end of the vertical hole 165 communicates with the insertion groove 164. A plurality of tubular seats 123 is formed on the peripheral wall 122. Each of the tubular seats 123 has a through hole 124. An extension direction of each of the through holes 124 is parallel to the axial direction of the rotation axis L. An exit 125 is formed at a bottom portion of the peripheral plate 12. The exit 125 communicates with the mounting space S.

Two side holes 142 are respectively provided at two middles of the two side plates 14. The side hole 142 of the side plate 14 on the left side is a circular hole. The side hole 142 of the side plate 14 on the right side is a non-circular hole. A top portion of each of the side plates 14 has two first through holes 143. The two first through holes 143 of each of the side plates 14 are respectively located at a front side and a rear side of the top portion of the corresponding side plate 14. Each of the first through holes 143 directly faces one of the perforations 162 along the axial direction of the rotation axis L. A plurality of second through holes 144 is formed at a portion of a periphery of each of the side plates 14. Each of the second through holes 144 corresponds to one of the through holes 124. Each of the second through holes 144 directly faces one of the through holes 124 along the axial direction of the rotation axis L.

Two first fixing members 18 are provided. Each of the first fixing members 18 passes through one of the perforations 162 and one of the first through holes 143 in each of the side plates 14. A part of each of the first fixing members 18 extends out of the fixing surface 161. Two second fixing members 19 are provided. Each of the second fixing members 19 passes through one of the through holes 124 and one of the second through holes 144 in each of the side plates 14. Each of the first fixing members 18 and each of the second fixing members 19 is a rivet structure. With the first fixing members 18 and the second fixing members 19, the two side plates 14 are respectively engaged with the left side and the right side of the peripheral plate 12 by riveting. In other embodiments, each of the first fixing members 18 and each of the second fixing members 19 could be a bolt and nut assembly and could be configured to engage the two side plates 14 with the left side and the right side of the peripheral plate 12 by screwing.

The ring assembly 20 includes a support plate 22, a rod 24, and a ring 26. The support plate 22 is a rectangular plate. The support plate 22 is inserted into the insertion groove 164 for fixing. A middle of the support plate 22 is provided with a rod hole 221. The rod hole 221 is located directly below the vertical hole 165. The rod 24 is a straight rod that is vertically provided. A bottom-halve of the rod 24 passes through the vertical hole 165. A bottom end of the rod 24 extends downwards out of the rod hole 221 of the support plate 22. A peripheral edge of the bottom end of the rod 24 is connected to a hook portion 241. The hook portion 241 is a circular disk. The hook portion 241 is stuck at a peripheral edge of a bottom end of the rod hole 221. A top end of the rod 24 extends upwards out of the top portion of the peripheral plate 12. The ring 26 is engaged with a top-end portion of the rod 24.

The stopper member 30 includes a fixed plate 32, a stopper tooth 34, and two protruding plates 36. A middle of the fixed plate 32 is provided with a positioning hole 321. The positioning hole 321 is sleeved around the positioning pin 163. Two fixed holes 322 are respectively provided on a front side and a rear side of the fixed plate 32. Each of the fixed holes 322 directly faces one of the perforations 162 along the axial direction of the rotation axis L. Each of the fixed holes 322 is sleeved around the part of one of the first fixing members 18 extending out of the fixing surface 161, so that the stopper member 30 is engaged with the fixing surface 161 through the fixed plate 32. The two protruding plates 36 are respectively connected to a front edge and a rear edge of the fixed plate 32. Each of the protruding plates 36 protrudes from the fixed plate 32 and extends out of one of the side walls 141 that is corresponding. Each of the protruding plates 36 abuts against the corresponding side wall 141, so that the fixed plate 32 is maintained at a state of tightly attaching to the fixing surface 161. A bottom portion of the fixed plate 32 extends downwards out of the fixing seat 16. The stopper tooth 34 is integrally connected to the bottom portion of the fixed plate 32.

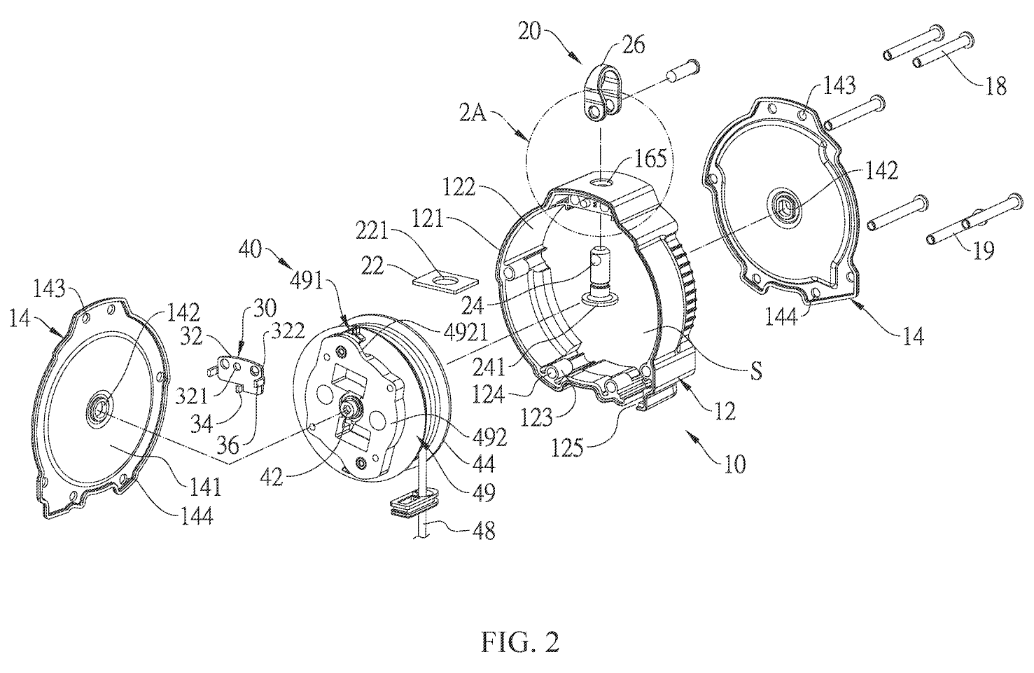

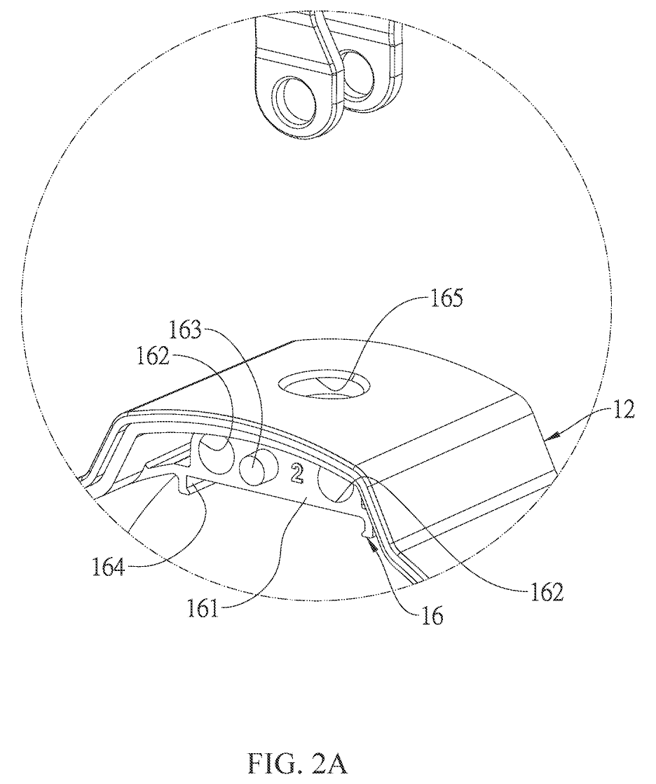

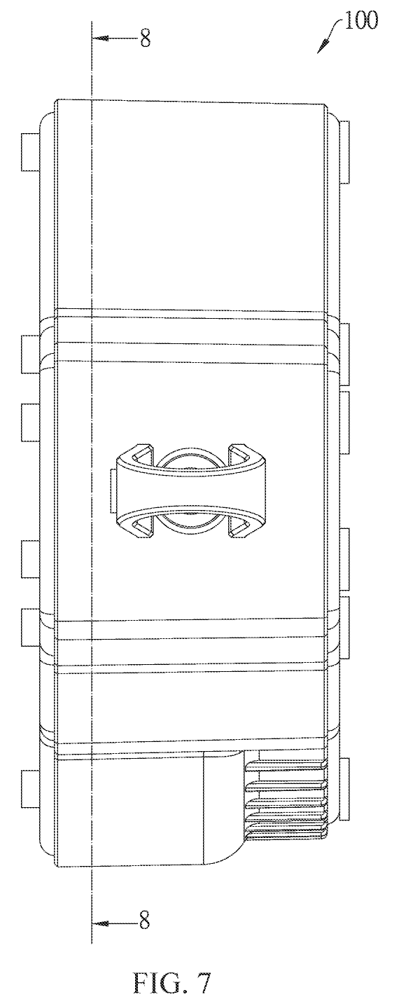

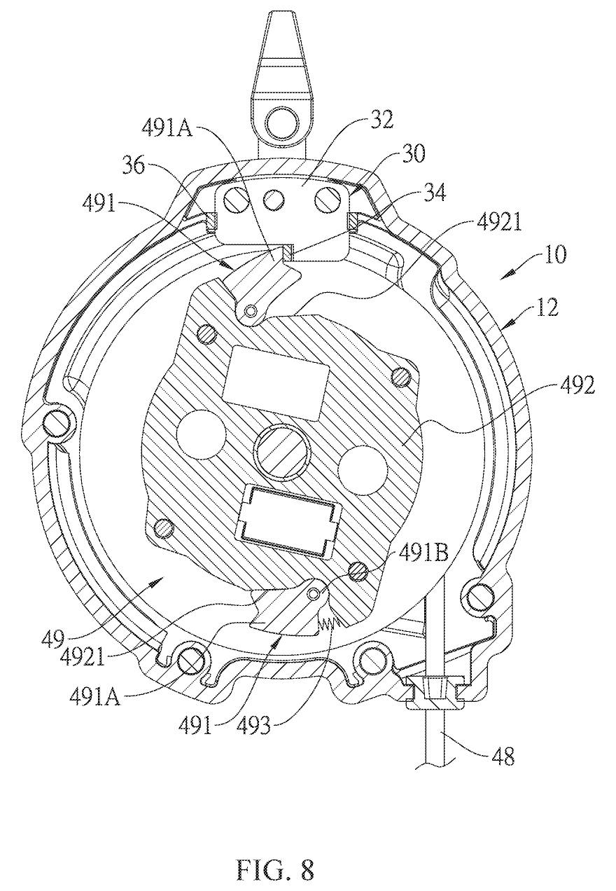

Referring to FIGS. 2 and 5-8 , the core assembly 40 includes a main shaft 42, a rotating drum 44, a spiral spring 46, a rope 48, and a braking assembly 49. Two ends of the main shaft 42 respectively pass through the two side holes 142, so that the main shaft 42 is fixed in the mounting space S. The rotation axis L is a central line of the main shaft 42. The rotating drum 44 is rotatably sleeved around the main shaft 42. A side of the rotating drum 44 is provided with a mounting portion 441. A spiral spring cavity 442 is provided in the rotating drum 44. The spiral spring 46 is disposed in the spiral spring cavity 442. Two ends of the spiral spring 46 are respectively connected to the main shaft 42 and the rotating drum 44.

An end of the rope 48 is engaged with the rotating drum 44. The rope 48 is wound around the rotating drum 44 in a releasable manner to have a plurality of turns. Another end of the rope 48 extends out of the exit 125 of the casing 10. The braking assembly 49 is engaged with the mounting portion 441 and includes a plurality of ratchet blocks 491. In the current embodiment, the braking assembly 49 includes a mounting disk 492 and two ratchet blocks 491. The mounting disk 492 is engaged with the mounting portion 441 of the rotating drum 44. Two ratchet grooves 4921 are respectively provided on two opposite sides of the mounting disk 492 along a circumferential direction of the mounting disk 492. Each of the ratchet blocks 491 is accommodated in one of the ratchet grooves 4921. Each of the ratchet blocks 491 includes a base portion 491A and a ratchet portion 491B connected to the base portion 491A. The base portion 491A of each of the ratchet blocks 491 is rotatably engaged with the mounting disk 492. Two compression springs 493 are provided. Each of the two compression springs 493 abuts and is disposed between the base portion 491A of one of the ratchet blocks 491 and a wall surface of one of the ratchet grooves 4921. Each of the compression springs 493 applies a biased elastic force to one of the ratchet blocks 491, so that each of the ratchet blocks 491 is at a closed state when no external force is applied. At that time, the ratchet portion 491B of each of the ratchet blocks 491 is accommodated in the corresponding ratchet groove 4921.

When the rope 48 is pulled out of the exit 125 by an external force, the rope 48 drives the rotating drum 44 to rotate around the main shaft 42, wherein a rotation direction of the rotating drum 44 at that time is defined as a forward rotation direction. On the contrary, when the external force pulling the rope 48 outwards is dismissed, the spiral spring 46 provides a resilient force for rotating the rotating drum 44 to an original position; at that time, the rotating drum 44 rotates reversely and retracts the released rope 48 into the casing 10.

When the rope 48 is pulled outwards by the external force and a rotational speed of the forward rotation of the rotating drum 44, which is driven by the rope 48, is greater than a predetermined rotational speed, a centrifugal force experienced by the ratchet blocks 491 due to the rotation of the rotating drum 44 is greater than the biased elastic force of the compression springs 493 exerting to the ratchet blocks 491. At that time, the ratchet portion 491B of each of the ratchet blocks 491 expands outwards, so that a rotational path, along which the ratchet blocks 491 rotate together with the rotating drum 44, intersects a position of the stopper tooth 34, thereby driving the ratchet portion 491B of one of the ratchet blocks 491, which rotates to the top, to mesh with the stopper tooth 34. At that time, the rotating drum 44 immediately stops from rotating. When the rotating drum 44 stops rotating, the rotating drum 44 stops releasing the rope 48. As the centrifugal force no longer occurs at that time, the other ratchet block 491, which is located at the bottom, is pushed by one of the compression springs 493 that is corresponding and returns from an expanded state to the closed state.

On the contrary, when the rope 48 is pulled outwards by the external force and the rotational speed is less than the predetermined rotational speed, the ratchet portions 491B of the ratchet blocks 491 do not expand and do not mesh with the stopper tooth 34. In this way, when the casing 10 is hung from a fixed place via the ring 26 and the another end of the rope 48 extending out of the exit 125 is engaged with a wearable harness on a user, the fall arrest device 100 could prevent the user from continuing to fall when falling from a height. At a normal condition, the rope 48 of the fall arrest device 100 extending outwards could be pulled out manually or by the movement of the user; when the user stops from continuously pulling out the rope 48, the rotating drum 44 could rewind the rope 48, preventing the overextended rope 48 from obstructing the operation of the user.

With the aforementioned design, the stopper member 30 is engaged with the fixing seat 16 inside the casing 10 and the stopper tooth 34 formed on a bottom portion of the stopper member 30 is configured to mesh with one of the ratchet blocks 491. In this way, the present invention does not require a ratchet gear or a braking structure, which is configured to mesh with the braking assembly 49 and is disposed along an axial direction of the main shaft 42. Therefore, in comparison with the structure having the ratchet gear disposed on the main shaft 42, the present invention could reduce a length of the main shaft 42 and a volume of the casing 10 along the axial direction of the rotation axis L, thereby reducing the size of the fall arrest device 100 and the weight of the fall arrest device 100.

It must be pointed out that the embodiment described above is only a preferred embodiment of the present invention. All equivalent structures which employ the concepts disclosed in this specification and the appended claims should fall within the scope of the present invention.

What is claimed is:

1. A fall arrest device, having a rotation axis, comprising:
a casing, wherein a mounting space is provided in the casing; two side walls are respectively provided on two sides of the mounting space in an axial direction of the rotation axis; a peripheral wall is connected between the two side walls; a fixing seat is formed on a top portion of the peripheral wall; an insertion slot is formed between the fixing seat and one of the two side walls; a fixing surface is formed on the fixing seat; the fixing surface faces the insertion slot; an exit is formed at a bottom portion of the peripheral wall; the exit communicates with the mounting space;
a ring assembly, engaged with a top portion of the casing;
a stopper member, engaged with the fixing surface, wherein a bottom portion of the stopper member extends downwards out of the fixing seat, and a stopper tooth is formed at the bottom portion of the stopper member; and
a core assembly, comprising a main shaft, a rotating drum, a spiral spring, a rope, and a braking assembly, wherein the main shaft is fixed in the mounting space; the rotation axis is a central line of the main shaft; the rotating drum is rotatably sleeved around the main shaft; a side of the rotating drum is provided with a mounting portion; a spiral spring cavity is provided in the rotating drum; the spiral spring is disposed in the spiral spring cavity and is connected between the main shaft and the rotating drum; an end of the rope is engaged with the rotating drum; the rope is wound around the rotating drum in a releasable manner to form a plurality of turns; another end of the rope extends out of the exit; the braking assembly is engaged with the mounting portion; a plurality of ratchet blocks is provided around the braking assembly; when a rotational speed of the plurality of ratchet blocks, which rotate together with the rotating drum, is greater than a predetermined rotational speed, one of the plurality of ratchet blocks meshes with the stopper tooth.

2. The fall arrest device as claimed in claim 1, wherein the stopper member has a fixed plate; the fixed plate is engaged with the fixing surface; the stopper tooth is integrally connected to the fixed plate.

3. The fall arrest device as claimed in claim 2, wherein two perforations are respectively provided on two sides of the fixing seat; an extension direction of each of the two perforations is parallel to the axial direction of the rotation axis; two first fixing members are provided; each of the two first fixing members passes through one of the two perforations; a part of each of the two first fixing members extends out of the fixing surface; two fixed holes are respectively provided on two sides of the fixed plate; each of the two fixed holes directly faces one of the two perforations along the axial direction of the rotation axis; each of the two fixed holes is sleeved around the part of one of the two first fixing members extending out of the fixing surface.

4. The fall arrest device as claimed in claim 3, wherein a positioning pin is provided on the fixing surface; the fixed plate has a positioning hole; the positioning hole is sleeved around the positioning pin.

5. The fall arrest device as claimed in claim 2, wherein two protruding plates are respectively connected to two sides of the fixed plate; each of the two protruding plates protrudes from the fixed plate and extends out of one of the two side walls that is corresponding; each of the two protruding plates abuts against the corresponding side wall, thereby maintaining the fixed plate at a state of tightly attaching to the fixing surface.

6. The fall arrest device as claimed in claim 1, wherein the casing comprises a peripheral plate and two side plates; the fixing seat is formed on a bottom side of a top portion of the peripheral plate; the peripheral wall is formed on an inner surface of the peripheral plate; two end edges are respectively provided on two side edges of the peripheral plate; a peripheral edge of each of the two side plates is connected to one of the two end edges; each of the two side walls is formed on an inner surface of one of the two side plates; a middle of each of the two side plates has a side hole; two ends of the main shaft are respectively fixed to the two side holes of the two side plates; the peripheral plate and the two side plates surround and define the mounting space.

7. The fall arrest device as claimed in claim 6, wherein an insertion groove is formed at a bottom portion of the fixing seat; a vertical hole is formed at the top portion of the peripheral plate and the fixing seat; the vertical hole communicates with the insertion groove; the ring assembly comprises a support plate, a rod, and a ring; the support plate is inserted into the insertion groove; a middle of the support plate has a rod hole; the rod passes through the vertical hole and a bottom end of the rod extends out of the rod hole; a peripheral edge of the bottom end of the rod is connected to a hook portion; the hook portion is stuck at a peripheral edge of a bottom end of the rod hole; the ring is engaged with a top end portion of the rod.

8. The fall arrest device as claimed in claim 6, wherein two perforations are respectively provided on a front side and a rear side of the fixing seat; an extension direction of each of the two perforations is parallel to the axial direction of the rotation axis; a top portion of each of the two side plates has two first through holes; each of the two first through holes directly faces one of the two perforations along the axial direction of the rotation axis; two first fixing members are provided; each of the two first fixing members passes through one of the two perforations and one of the two first through holes in each of the two side plates; a part of each of the two first fixing members extends out of the fixing surface; two fixed holes are respectively provided on a front side and a rear side of the stopper member; each of the two fixed holes is sleeved around the part of one of the two first fixing members extending out of the fixing surface.

9. The fall arrest device as claimed in claim 6, wherein a plurality of tubular seats is formed on the peripheral wall; each of the plurality of tubular seats has a through hole; a plurality of second through holes is formed at a portion of a periphery of each of the two side plates; each of the plurality of second through holes corresponds to the through hole of one of the plurality of tubular seats; a plurality of second fixing members is provided; each of the plurality of second fixing members passes through the through hole of one of the plurality of tubular seats and one of the plurality of second through holes in each of the two side plates; the two side plates are engaged with two sides of the peripheral plate through the plurality of second fixing members.
